(19) United States
(12) Patent Application Publication
(10) Pub. No.: US 2025/0259351 A1
(43) Pub. Date: Aug. 14, 2025

(54) DRAWING TOOL WITH DYNAMIC SHAPE GENERATION

(71) Applicant: Bas Ording, San Francisco, CA (US)

(72) Inventor: Bas Ording, San Francisco, CA (US)

(21) Appl. No.: 18/440,872

(22) Filed: Feb. 13, 2024

(51) Int. Cl. G06T 11/20; G06T 7/12; G06T 7/73

(52) U.S. Cl. CPC G06T 11/203; G06T 7/12; G06T 7/73; G06T 2200/24; G06T 2207/20092; G06T 2210/21

(57) ABSTRACT

Exemplary methods, apparatuses, and systems include receiving a continuous sequence of user inputs to draw a line. A shape is selected from a plurality of shapes by determining if a set of the intermediate coordinates satisfies a straight line threshold. The line is displayed to conform to the predefined shape by omitting or adjusting one or more intermediate coordinates. In response to additional user input, an updated shape is selected from the plurality of shapes by determining if the updated set of intermediate coordinates satisfies the straight line threshold. An updated output is sent to the display the line to conform to the updated shape by omitting or adjusting one or more of the updated intermediate coordinates. The updated shape is a different one of the plurality of shapes.

### FIELD OF THE INVENTION

The various embodiments described in this document relate to graphic design tools. In particular, embodiments relate to design tools that dynamically detect, generate, and update shapes in response to imprecise user input.

### BACKGROUND OF THE INVENTION

Graphic design tools allow a user to create designs using one or more of a personal computer, tablet, virtual reality headset, etc. These tools receive drawing input via a mouse, touchscreen, or other detection of movement of, e.g., a controller, stylus, finger, hand, etc. Such inputs are often imprecise when the user is attempting to generate a straight line, circular arc, or other intended shape. As such, conventional tools provide selectable predefined shapes such that user inputs will be limited to the shape selected before providing drawing inputs. For example, selection of a straight line as a predefined shape allows a user to generate a straight line by providing inputs of a starting point and ending point, without needing to accurately draw intermediate points along the straight line. Alternatively, other conventional tools interpret a user input at the end of a continuous sequence of user inputs to select a shape and conform the user inputs to the selected shape. Returning to the example of a straight line, a user may draw an imprecise straight line and “hold” a final point of input for a threshold amount of time to trigger the tool to detect that a line has been drawn and update the imprecise line by adjusting the path of inputs to conform to a precise straight line between the starting point and the final point of input that was held.

### BRIEF DESCRIPTION OF THE DRAWINGS

The present invention is illustrated by way of example and not limitation in the FIG.s of the accompanying drawings, in which like references indicate similar elements, and in which:

FIG. 1 illustrates a sequence of user inputs detected to satisfy a straight line threshold and the corresponding dynamic output of a straight line;

FIG. 2 illustrates a continuation of the sequence of user inputs, an updated detection of the inputs satisfying a circular arc threshold, and the corresponding dynamic output of a circular arc;

FIG. 3 illustrates the detection of the circular arc satisfying a relationship threshold with a previously drawn line or shape;

FIG. 4 illustrates the dynamic adjustment of the circular arc into the relationship with the previously drawn line or shape in response to satisfying the relationship threshold;

FIG. 5 illustrates a continuation of the sequence of user inputs and an updated detection of the inputs satisfying an inflection threshold and the corresponding dynamic output of arc with an inflection;

FIG. 6 illustrates an alternate continuation of the sequence of user inputs and an updated detection of the inputs satisfying a vertex threshold and the corresponding dynamic output of straight lines sharing an endpoint to create a vertex of an angle;

FIG. 7 illustrates an alternate continuation of the sequence of user inputs and an updated detection of the inputs satisfying a rectangle threshold and the corresponding dynamic output of a rectangle;

FIG. 8 illustrates an additional sequence of user inputs detected to satisfy a vertex threshold and the corresponding dynamic output of straight lines sharing an endpoint to create a vertex of an angle intersecting the rectangle;

FIG. 9 illustrates a continuation of the sequence of user inputs and an updated detection of the inputs satisfying an erasure threshold;

FIG. 10 illustrates the updated rectangle following the detection of the erasure;

FIG. 11 illustrates an output resulting from a first sequence of user inputs detected as satisfying a circular arc threshold;

FIG. 12 illustrates an output during a second sequence of user inputs detected as satisfying a circular arc threshold;

FIG. 13 illustrates an output resulting from detecting a threshold relationship between endpoints of the first and second sequences of user inputs;

FIG. 14 is a flow chart illustrating an exemplary method of dynamic shape generation;

FIG. 15 is another flow chart illustrating an exemplary method of dynamic shape generation; and

FIG. 16 illustrates, in block diagram form, an exemplary computer system in which embodiments of the present disclosure can operate.

### DETAILED DESCRIPTION

This document describes embodiments that dynamically detect, generate, and update shapes in response to imprecise user input. For example, embodiments can detect if user input including a continuous set of coordinates satisfies a threshold and, in response, select and display a predetermined shape by modifying one or more of the coordinates. Additionally, as the input continues with additional coordinates, embodiments can update the predetermined shape, including selecting and displaying a different shape. As a result, a user does not need to select a single, predetermined shape tool prior to drawing a line or provide a secondary type of input, such as holding an endpoint coordinate for a period, to modify the line to conform to a particular shape. The dynamic detection, generation, and updating of a line drawn by the user gives the user visual feedback while drawing the line as well as the flexibility to draw aesthetically pleasing shapes that are more likely aligned with the user's intention in less time and with less effort than required with the additional inputs of conventional tools. Furthermore, embodiments can use a predefined shape or pattern for another functionality than drawing a line in said shape or pattern. For example, the detection of a plurality of angles in a zigzag pattern can result in an erasure of previously drawn lines in the area covered by the pattern. As a result, the user can quicky erase a portion of a drawing without the preselection of an erase tool.

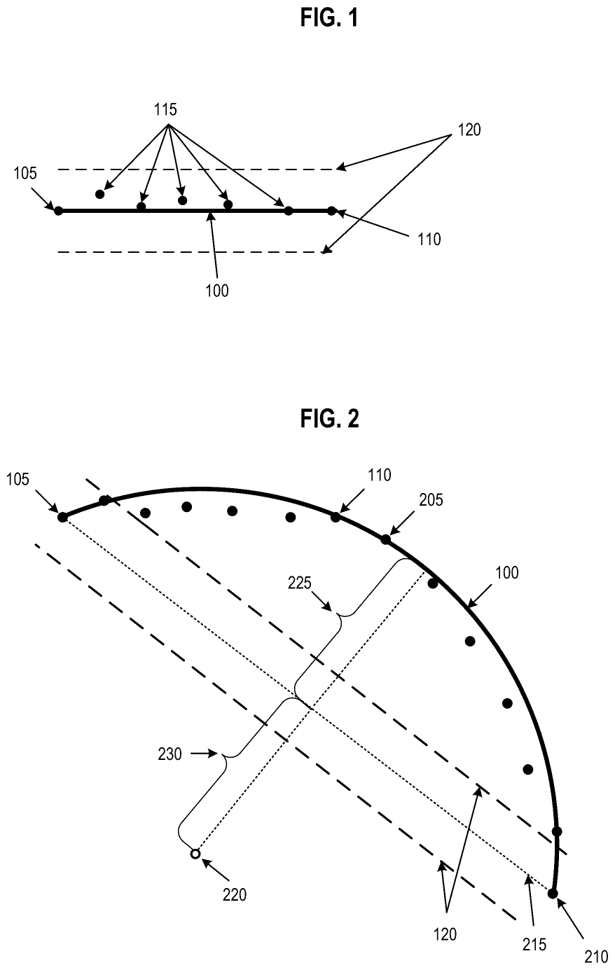

FIG. 1 illustrates a continuous sequence of user inputs detected to satisfy a straight line threshold and the corresponding dynamic output of a straight line 100. For example, a continuous sequence of user inputs can result from a user interacting with a touch screen with a finger or stylus, detection of movement of a mouse or other controller while depressing a button, or an equivalent input for a phone, tablet, computer, virtual/augmented reality headset, etc. that a design or drawing tool uses to draw a line. For simplicity of explanation, examples set forth below will use the combination of a stylus and touchscreen to describe user inputs. Embodiments are not limited to such inputs and the examples apply to other devices and input types for drawing a line.

As illustrated, the continuous sequence of user inputs includes the starting set of coordinates 105 corresponding to where the drawing input initiates, the latest set of coordinates 110 the drawing input has currently reached while an embodiment dynamically detects and generates the displayed line/shape, and intermediate sets of coordinates 115 corresponding to the path of input travels. For example, these sets of coordinates represent a sampling of coordinates resulting from the path the stylus moves while in contact with a touchscreen. That path would pass from the starting set of coordinates 105, through each of the intermediate coordinates 115, up to the latest set of coordinates 110, which forms an indirect path from the starting set of coordinates 105 to the latest set of coordinates 110 (i.e., not a straight line).

Embodiments detect that the coordinates satisfy a threshold for a straight line and, in response, generate a display of the straight line 100. For example, the threshold for a straight line can include the coordinates falling within the space between parallel lines 120 at a predetermined distance on either side of the straight line 100 between the initial set of coordinates 105 and latest set of coordinates 110. The parallel lines 120 are illustrated as broken lines to emphasize that the parallel lines 120 are used as a threshold but not necessarily displayed to a user. Additionally, the points representing the sets of coordinates 105-115 are for purposes of explanation and may also be omitted from the drawing displayed to the user. As a result of detecting the drawing input satisfies the threshold for a straight line, the user is granted leeway in a lack of precision of the straightness of the path of the input while drawing the straight line 100. This overcomes the difficulty in moving a stylus in a precisely straight line while in contact with a touchscreen (or equivalent drawing input). Additionally, the user can proceed directly to drawing without, e.g., preselecting a straight line drawing mode and limiting drawing to straight lines until a different drawing mode is selected.

The straight line 100 is generated by omitting and/or modifying one or more of the intermediate sets of coordinates 115. Additionally, the straight line 100 is displayed to the user dynamically. In other words, embodiments do not require the user to end and/or delay the drawing input at the latest set of coordinates 110 to render the straight line 100.

In some embodiments, the threshold for a straight line includes an additional factor. For example, an embodiment can use the speed of movement of the stylus while receiving the drawing input as another threshold for selecting and displaying a shape that does not precisely conform to the sets of coordinates. A movement speed greater than a threshold speed can trigger the dynamic shape selection and display described above while a movement speed less than the threshold speed can trigger the generation and display of the line that directly corresponds to the path of movement through the intermediate coordinates 115 (i.e., a line that is not a straight line between the initial set of coordinates 105 and latest set of coordinates 110).

FIG. 2 illustrates a continuation of the sequence of user inputs, an updated detection of the inputs satisfying a circular arc threshold, and the corresponding dynamic output of a circular arc 100. For example, the sequence of user inputs includes a continuation of the stylus moving across a touchscreen corresponding to the intermediate set coordinates 205 to an updated latest set of coordinates 210. The set of coordinates referred to above as the latest set of coordinates 110 joins the other sets of intermediate coordinates. In one embodiment, the continuation of the sequence of user inputs represents an updated shape evaluation of a single line drawn by the user starting at the initial set of coordinates 105 to the updated latest set of coordinates 210, e.g., without ending or otherwise interrupting contact between the stylus and touchscreen.

In one embodiment, satisfying a circular arc threshold includes one or more intermediate sets of coordinates falling outside of the threshold for a straight line. For example, an embodiment determines a straight line 215 between the initial set of coordinates 105 and the updated latest set of coordinates 210 as well as updated parallel lines 120 on either side of the straight line 215. Again, broken lines in the illustration are used to emphasize lines used in determining a shape that are not necessarily displayed to a user. Additionally, embodiments can detect the satisfaction of a circular arc threshold when the intermediate coordinates are on one side of the straight line 215, one side of at least one of parallel lines 120, or at least a percentage or threshold amount of intermediate coordinates satisfy such a condition.

In some embodiments, satisfying the circular arc threshold further includes the intermediate sets of coordinates falling inside a threshold distance of the circular arc 100 passing from the initial set of coordinates 105 to the updated latest set of coordinates 210. For example, embodiments can determine concentric circular arcs (not illustrated) on either side of the circular arc 100 and detect that the intermediates coordinates fall within those concentric circular arcs. The determination of a circular arc is described further below.

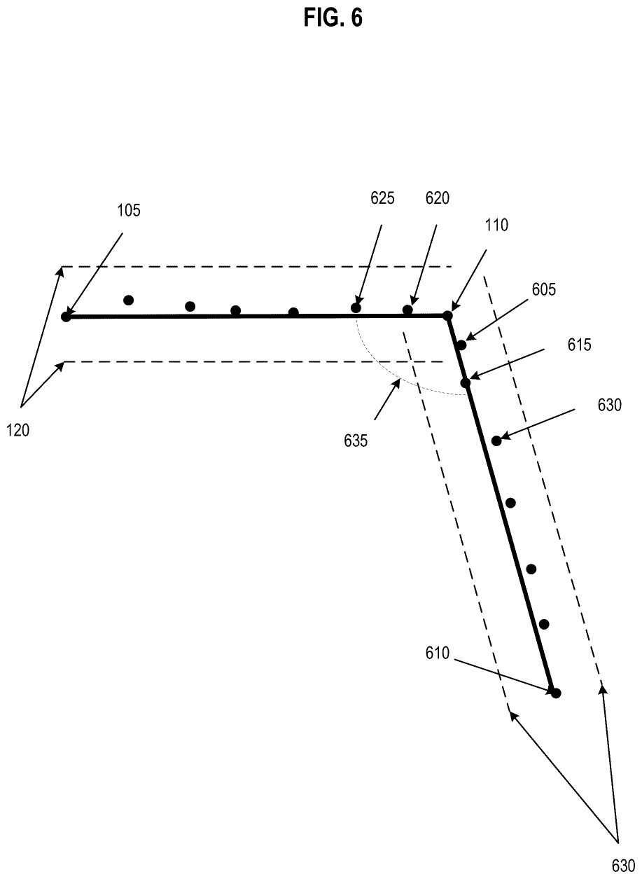

In some embodiments, satisfying the circular arc threshold further includes the intermediate sets of coordinates failing to satisfy a vertex threshold. Examples of satisfying a vertex threshold, and the corresponding displaying straight lines intersecting at a vertex at a determined angle, are described further below with reference to FIG. 6.

The determination of the path of the circular arc 100, and corresponding adjustment or omission of one or more sets of intermediate coordinates, includes determining a center point 220. The center point 220 is determined by using the straight line 215 as a chord that divides a circle into two portions, one portion being the circular arc 100. The length of the straight line 215 serves as a width (W) of the circular arc 100. A maximum distance of the sets of intermediates coordinates in direction perpendicular from the straight line 215 serves as the circular arc height (H) 225. The radius (R) of the circle is determined to perpendicularly intersect the center point of the straight line 215 and travels from the center point 220 for a determinable distance 230 represented as R-H. As such, the center point, radius, and corresponding circular arc can be determined by finding a value for R that satisfies the equation (R−H)²+(W/2)²=R².

As additional coordinates are added as a part of the sequential user inputs (e.g., continuous contact and movement of a stylus across a touchscreen), or as an optimization, embodiments can adjust the radius of the circular arc and corresponding path of the circular arc. For example, an embodiment can average distances between coordinates and the center point 220 and adjust the radius using the average distance value. In one embodiment, the new radius is equal to the average distance. In another embodiment, the new radius is increased or decreased by an incremental amount in the direction of the average distance.

Additionally, embodiments can track the progress of a line toward the partial or total completion of a predefined shape and, if within a threshold distance, adjust the line to conform to such a partial or complete shape. Continuing with the example of a circular arc, an embodiment can track the progress of completion of a circle by quadrants or another subdivision of a circle. If the starting coordinates 105 and most recent coordinates 210 are within a threshold distance of completing a quarter circle, half circle, three-quarter circle, or complete circle, an embodiment can adjust the circular arc 100 to display the corresponding quarter circle, half circle, three-quarter circle, or complete circle.

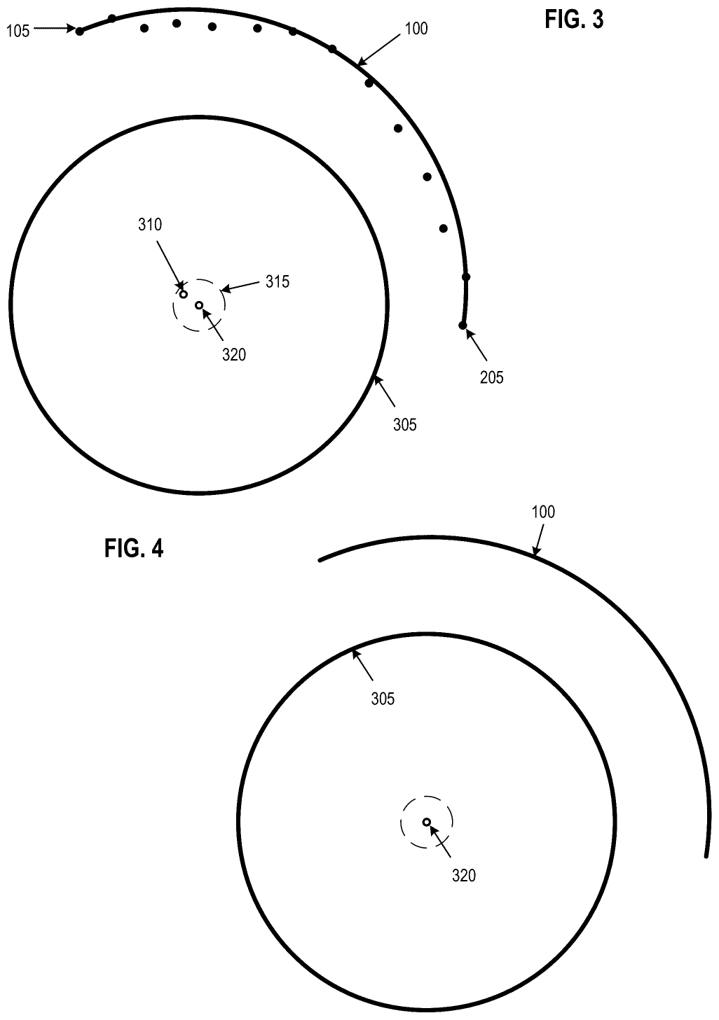

FIG. 3 illustrates the detection of the circular arc 100 satisfying a relationship threshold with a previously drawn line or shape 305. As described above, embodiments can detect a sequence of inputs including a starting set of coordinate 105, an ending or most recent set of coordinates 205, and one or more intermediate sets of coordinates, determine that the coordinates correspond to a line satisfying a circular arc threshold, and display the circular arc 100 by omitting and/or adjusting one or more of the coordinates that were part of the sequence of inputs. Additionally, embodiments can determine if the circular arc 100 satisfies a relationship with a previously drawn line or shape, such as the circle 305. For example, embodiments can determine the relationship is satisfied if the center 310 of the circular arc 100 is within a threshold distance 315 of the center 320 of the circle 305. Alternatively, embodiments can determine the relationship is satisfied if the sets of coordinates of the circular arc 100 (or a percentage thereof) are within a threshold distance of equidistant from corresponding points of the circle 305. For example, embodiments can determine parallel arcs/concentric circles of varying radii from the center 320 of the circle 305 and detect if the circular arc 205 falls in between the determined parallel arcs/concentric circles.

While the illustrated example describes detecting a relationship between a combination of circles and/or circular arcs, embodiments can detect similar relationship thresholds for other lines and/or shapes. Nonlimiting examples include, for example, detecting parallel lines, detecting multi-side shapes sharing a center or vertex, midpoint intersections, orthogonal and tangential relationships, etc. For ease of explanation, however, the illustrated examples in FIGS. 3-4 focus on a concentric relationship. Additionally, embodiments can use other factors in determining whether a relationship is satisfied between lines/shapes. For example, an embodiment can use the speed of movement of the stylus while receiving the drawing input as another threshold for determining whether or not to detect a possible relationship. A movement speed greater than a threshold speed can trigger the dynamic line/shape relationship detection described above while a movement speed less than the threshold speed can override the relationship detection.

FIG. 4 illustrates the dynamic adjustment of the circular arc 100 into the relationship with the previously drawn line or shape 305 in response to satisfying the relationship threshold as described above. Continuing with the example of a concentric relationship, an embodiment moved one or both of the circular arc 100 and the circle 305 such that they now share a common center point 320. Embodiments can determine which line/shape to move in response to detecting a relationship being satisfied using one or more factors, including: an order of drawing (e.g., moving the later drawn line/shape), whether the move will disrupt another relationship (e.g., another parallel, concentric, etc. relationship), the number of coordinates that will be adjusted by moving the line/object, etc.

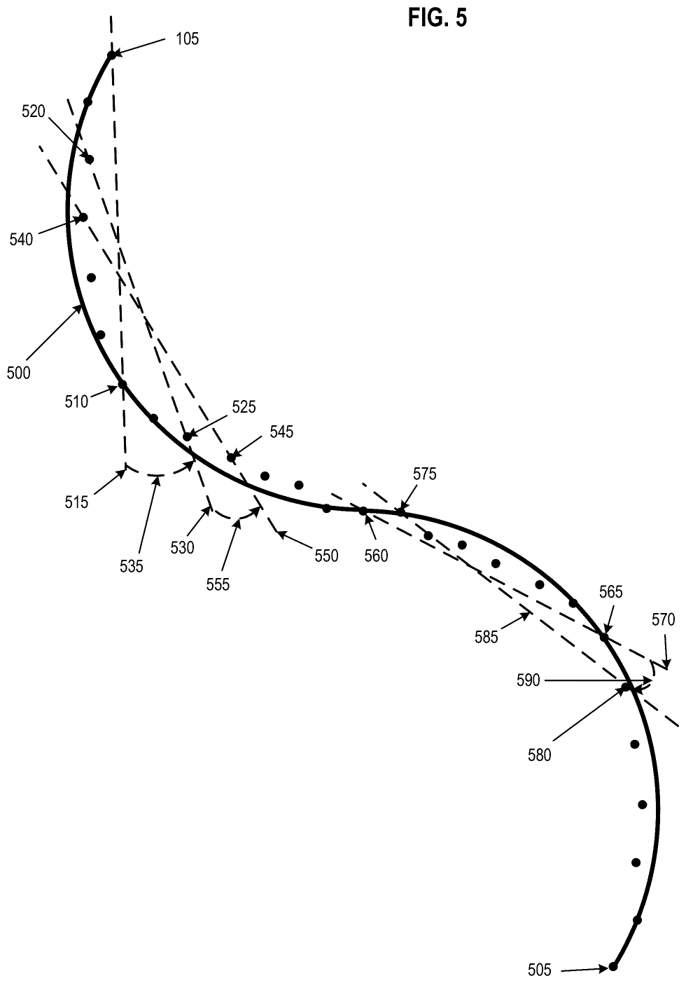

FIG. 5 illustrates a continuation of the sequence of user inputs and an updated detection of the inputs satisfying an inflection threshold and the corresponding dynamic output of arc 500 with an inflection. Similar to the description above, embodiments can detect a sequence of inputs including a starting set of coordinate 105, a most recent set of coordinates 505, and one or more intermediate sets of coordinates. At a point in receiving the continuous sequence of user inputs (e.g., stylus moving across a touchscreen) at which the intermediate coordinates 560 are the most recent set of coordinates, an embodiment determines that the inputs correspond to a line 500 satisfying a circular arc threshold and displays the circular arc 500 by omitting and/or adjusting one or more of the coordinates that were part of the sequence of inputs.

In addition to detecting the satisfaction of a circular arc threshold, embodiments can detect if an inflection threshold is satisfied by determining an angular direction of chords of the circular arc and detecting a change in that angular direction. For example, continuous user input can be sampled for coordinates received at a minimum distance (e.g., 50 pixels, 10 millimeters, or another distance in terms of drawing input or display output) from the last, minimum time between receiving coordinates, etc. and chords can be determined between coordinates at a given interval. The illustrated example includes a first chord 515 passing through the starting coordinates 105 and intermediate coordinates 510, a second chord 530 passing through the intermediate coordinates 520 and 525, and an angular direction 535 between the first chord 515 and the second chord 530. As shown, this angular direction 535 is counterclockwise.

Chords can be evaluated at a regular or irregular interval. For example, the illustrated example skips intermediate coordinates between the starting coordinates 105 and intermediate coordinates 520. No intermediate coordinates are skipped however, in determining a third chord 550 passing through intermediate coordinates 540 and intermediate coordinates 545 and detecting the angular direction 555 between the second chord 530 and the third chord 550. Additionally, a minimum number of coordinates, time between inputs, or other measurement can serve to select starting and ending points of each chord. Embodiments can evaluate more or fewer chords than illustrated. In some embodiments, chords are selected such that there is a minimum angle between successive chords. For example, a minimum angle, such as 6 degrees, provides a tolerance for imperfections in the continuous drawing input received from the user that can otherwise be interpreted as an inflection.

Continuing along the line 500 as the continuous inputs are received, an embodiment detects a change in angular direction when evaluating a fourth chord 570 that passes through intermediate coordinates 560 and 565 and a fifth chord 585 that passes through intermediate coordinates 575 and 580. The angular direction 590 of these chords is clockwise (i.e., in the opposite direction from the angular direction of the progression of previous chords). In response to detecting the change of angular direction, embodiments can select a point to subdivide the line 500 at a point of inflection 560 and dynamically generate shapes for each segment of the line 500. For example, the earliest set of intermediates coordinates 560 that are included in a chord used to detect the change of angular direction can serve as a point of inflection or otherwise subdivide a line into distinct shapes. While the illustrated example includes a pair of circular arcs joined at the point of inflection 560, other examples can include subdividing the line into a circular arc and a straight line or another combination of shapes.

FIG. 6 illustrates an alternate continuation of the sequence of user inputs and an updated detection of the inputs satisfying a vertex threshold and the corresponding dynamic output of straight lines sharing an endpoint to create a vertex of an angle. For example, the sequence of user inputs includes a continuation of the stylus moving across a touchscreen corresponding to the intermediate set coordinates 605 to an updated latest set of coordinates 610. The set of coordinates referred to above as the latest set of coordinates 110 joins the other sets of intermediate coordinates. In one embodiment, the continuation of the sequence of user inputs represents an updated shape evaluation of a single line drawn by the user starting at the initial set of coordinates 105 to the updated latest set of coordinates 610, e.g., without ending or otherwise interrupting contact between the stylus and touchscreen.

In one embodiment, satisfying a vertex threshold includes one or more intermediate sets of coordinates falling outside of the threshold for a straight line. For example, similar to the descriptions above, an embodiment determines a straight line between the initial set of coordinates 105 and the updated latest set of coordinates 610 as well as updated parallel lines (not shown) on either side of the straight line. Intermediate coordinates 110 (as well as others) would fall outside of the space defined by such parallel lines.

Additionally (or independently), an embodiment iterates through sets of coordinates to measure an angle created by the sets of coordinates. The sampling of coordinates can include selecting points along the path of continuous inputs that have a minimum distance from one another, e.g., 50 pixels, 10 millimeters, or another distance in terms of drawing input or display output. Again, the points illustrated in FIG. 6, similar to the dashed lines, are for the purposes of explaining the satisfaction of the vertex threshold and are not necessarily a part of the displayed output. For example, three sets of coordinates serve to calculate an angle. An embodiment tracks a smallest angle measured and the set of coordinates that serve as the vertex of that angle. For example, an evaluation of intermediates coordinates 625, 620, and 110 yields a large angle (close to 180 degrees) as the path through these sets of coordinates is approximately a straight line. An evaluation of intermediate coordinates 620, 110, and 605, however, yields a sharper angle 635 (approximately 100 degrees). An evaluation of intermediate coordinates 110, 605, and 615 again yields a large angle. Iterations along the line would similarly yield larger angles. As such, an embodiment tracks the set of coordinates 110 as a vertex of the smallest angle 635 of coordinates along the line. In some embodiments, however, detecting a sequence of an angle that is shaper by a threshold amount than the angles on either side of it triggers the detection of a vertex or subsequent detection step (e.g., testing for straight segments on either side as described below) to detect a vertex.

In addition to detecting the smallest angle 635, an embodiment tracks the smallest angle 635 with larger angles on either side and/or a threshold difference between the smallest angle 635 and angles on either side. For example, as described above, an embodiment detects larger angles on either side of the angle 635 created by intermediate coordinates 620, 110, and 605. In one embodiment, the detection of larger angles includes determining that the angles on either side of the smallest angle are within a threshold number of degrees from 180 degrees. For example, a smallest angle with coordinates on either side that are within 5 degrees of a straight line can be detected as straight lines intersecting at a vertex created by the smallest angle 635.

Additionally (or independently), an embodiment divides the line into segments at the vertex created by the smallest angle and determines if each segment satisfies the straight line threshold. For example, similar to the description above, the threshold for a straight line for the first segment can include the coordinates falling within the space between parallel lines 120 between the initial set of coordinates 105 and set of coordinates 110 detected to be the vertex of the smallest angle. The threshold for a straight line for the second segment can include the coordinates falling within the space between parallel lines 630 between the set of coordinates 110 detected to be the vertex of the smallest angle and the latest set of coordinates 610. In response to satisfying the straight line threshold, each segment is displayed as a straight line intersecting at the vertex 110.

While the illustrated example includes a pair of straight lines joined at the vertex 110, other examples can include subdividing the line into a straight line and circular arc meeting at the vertex 110, or another combination of shapes. Additionally, as described below, the continuation of user inputs can lead to further adjustment of points and the dynamic display of a polygon or another shape.

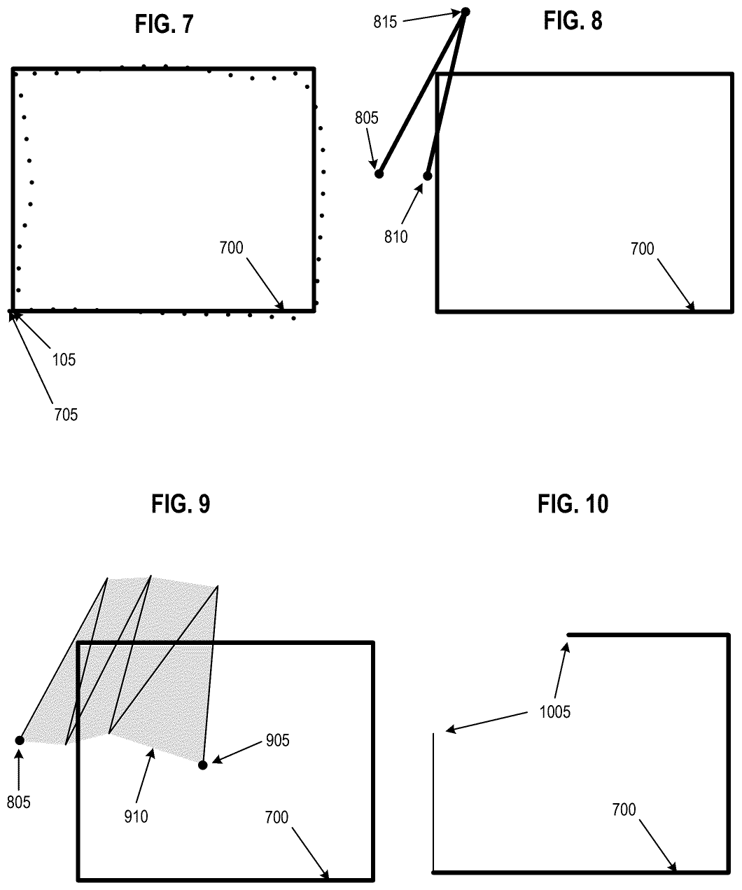

FIG. 7 illustrates an alternate continuation of the sequence of user inputs and an updated detection of the inputs satisfying a rectangle threshold and the corresponding dynamic output of a rectangle 700. While this example describes detecting that inputs satisfy the rectangle threshold, embodiments can detect and dynamically display other polygons and shapes in a similar manner. The sequence of user inputs includes a continuation of the stylus moving across a touchscreen corresponding to an initial set of coordinates 105, intermediate sets coordinates, to a latest set of coordinates 710 that is the same as or within a threshold distance of the initial set of coordinates 105. Using the detection and display of straight line segments intersecting at vertices as described above, imperfect user drawing input is dynamically adjusted to display a precise rectangle 700.

In one embodiment, the detection of a vertex with an angle within a threshold number of degrees of a preferred angle triggers the adjustment of the user input to conform to the preferred angle. For example, an embodiment can dynamically generate a precise rectangle 700 by biasing angles of vertex to be ninety degrees. As a result, user input that includes line segments that are not precisely straight and vertices with angles within a range of, e.g., eighty seven to ninety three degrees, can be detected as drawing input to draw a rectangle 700 with straight sides and vertices having ninety degree angles. Other common angles can similarly be weighted or biased—e.g., increments of fifteen degrees, increments of thirty degrees, increments of forty five degrees, etc.

In one embodiment, the detection of a second or subsequent vertex triggers a determination of whether a relationship threshold between segments is satisfied. For example, an embodiment can implement a bias for a polygon to have sides of equal length, parallel sides, or other common geometric properties. In the example of the rectangle 700, top and bottom sides are parallel and have equivalent lengths, as do the right and left sides. In one embodiment, the detection of two sequential vertices that have or are adjusted to have ninety degree angles triggers the bias of having parallel sides with equivalent lengths. As a result, the path of the left and right sides of rectangle 700, as drawing inputs are received, can be adjusted when within a threshold number of degrees of being parallel to being parallel and/or within a threshold measurement (e.g., in pixels, millimeters, etc.) of being equal in length to precisely being equal in length. As another example, if all four sides of the rectangle are within a threshold measurement of being equal in length, an embodiment can dynamically adjust all four sides to be equal in length and display a precise square.

In one embodiment, the detection of the drawing input reaching (e.g., at or near the latest set of coordinates 705) a threshold proximity to the starting set of coordinates 105 triggers the dynamic selection and display of a closed shape. For example, while the latest set of coordinates 705 is past or to the left of the initial set of coordinates 105, an embodiment can detect that the latest set of coordinates 705 is within a threshold radius/distance from the initial set of coordinates 105 and dynamically adjust the segments of the line to close the shape by displaying the starting and ending of the line in the same set of coordinates and completing, in this example, a precise rectangle 700. In one embodiment, each detected vertex and segments triggers an adjustment to display one or more of precise straight lines, biased angles, etc. In another embodiment, the detection of the drawing input reaching the threshold proximity to the starting set of coordinates 105 triggers the dynamic display adjustments. As a result, the display can morph an imperfect, sloppy quadrilateral into a precise rectangle 700 during the final line inputs.

Similar to the examples above, the speed of user inputs (e.g., the speed of the drawing stroke of the stylus traveling across the touchscreen) can serve as a trigger or factor in the dynamic detection and display of a polygon or other shape. For example, user input received below a threshold speed can prevent one or more of the adjustments described above and/or a user input speed above a threshold speed can trigger one or more of the adjustments described above.

FIG. 8 illustrates an additional sequence of user inputs detected to satisfy a vertex threshold and the corresponding dynamic output of straight lines sharing an endpoint to create a vertex of an angle intersecting the rectangle 700. For example, the sequence of user inputs includes a starting set of coordinates 805 and latest set of coordinates 810. Similar to the description above, the dynamic detection of the user inputs satisfying the vertex threshold triggers the dynamic segmentation of the line into two straight line segments intersecting at the detected vertex 815. In one embodiment, the detection of an initial acute angle (e.g., less than forty-five degrees) triggers the monitoring for a pattern of sequential angles (a “zigzag” pattern), which is described further with reference to FIGS. 9-10.

FIG. 9 illustrates a continuation of the sequence of user inputs and an updated detection of the inputs satisfying an erasure threshold. In one embodiment, the erasure threshold is a number of angles detected in a zigzag pattern. For example, the sequence of user inputs continues to an updated latest set of coordinates 905 with multiple angles creating the zigzag pattern across the display. Once an initial acute angle triggers monitoring for a zigzag pattern, one or more sequential angles trigger an erasure operation. In one embodiment, each angle in the zigzag pattern is detected as having an acute angle that is less than a threshold number of degrees. In another embodiment, only the first or a subset of the angles are detected as having acute angles less than the threshold of degrees to trigger the erasure.

Similar to the examples above, the speed of user inputs (e.g., the speed of the drawing stroke of the stylus traveling across the touchscreen) can serve as a trigger or factor in the dynamic detection of an erase operation. For example, user input received below a threshold speed can prevent the triggering of an erasure and/or a user input speed above a threshold speed can trigger an erasure.

In response to a zigzag pattern triggering an erasure, an embodiment determines an area of the resulting shape, as illustrated by the shaded area 910. An existing drawing that intersects with the erasure area 910 is erased at the end of the sequence of user inputs. For example, when the user inputs stop the zigzag pattern in response to the stylus breaking contact with the touchscreen, the erasure area 910 is determined by connecting nearby vertices and drawing within the area is deleted.

FIG. 10 illustrates the updated rectangle 700 following the detection of the erasure. As shown, the updated shape is no longer a closed rectangle and the portion that was within the erasure area 910 has been removed from the display. The resulting open shape/updated rectangle 700 is open between new end points 1005.

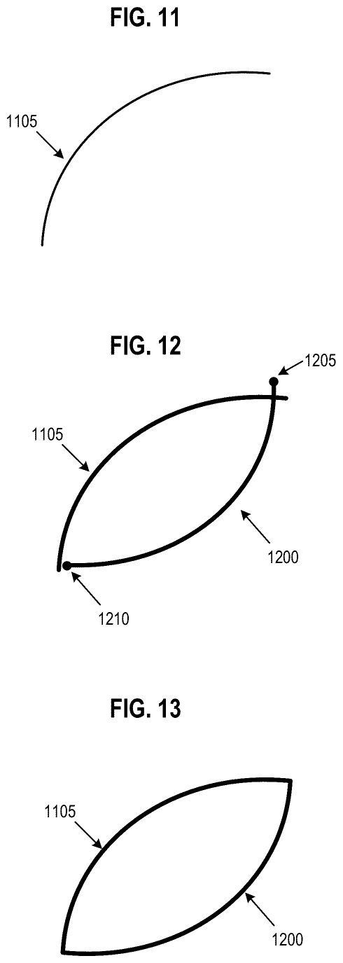

FIG. 11 illustrates an output resulting from a first sequence of user inputs detected as satisfying a circular arc threshold. Similar to the description of FIG. 2 above, satisfying a circular arc threshold can include one or more intermediate sets of coordinates falling outside of the threshold for a straight line and/or failing to satisfy a vertex threshold. In this example, the sequence of user inputs has a beginning and end, such that embodiments evaluate a subsequent sequence of user inputs as a new line that can either be drawn independently of circular arc 1105 or result in a dynamic modification due to a detected relationship with the circular arc 1105.

FIG. 12 illustrates an output during a second sequence of user inputs detected as satisfying a circular arc threshold. Continuing with the example above, a new line 1200 has been drawn with starting coordinates 1205 and latest/ending coordinates 1210. Similar to the descriptions above, this second line 1200 satisfies the circular arc threshold and an embodiment can omit or adjust one or more coordinates of the user input path to display the circular arc. Additionally, an embodiment can detect one or more relationships between the first line 1105 and the second line 1200. Exemplary relationships include, but are not limited to, starting/ending/center points within a threshold proximity to one another, lines within a threshold amount of degrees of being parallel, lines within a threshold amount of degrees of being perpendicular to one another, etc.

In the illustrated example, the starting and ending points of the lines are within a threshold distance of one another. As a result, embodiments can adjust one or both lines to display the proximate coordinates in the same location. An adjustment can include shortening a line, lengthening a line, and/or moving a line in two-dimensional space to align start/endpoints. One embodiment selects the adjustment or combination of adjustments that result the least change to the line received as user input.

Similar to the examples above, the speed of user inputs (e.g., the speed of the drawing stroke of the stylus traveling across the touchscreen) can serve as a trigger or factor in the dynamic detection of relationship threshold. For example, user input received below a threshold speed can prevent the triggering of a relationship adjustment and/or a user input speed above a threshold speed can trigger a relationship adjustment.

FIG. 13 illustrates an output resulting from detecting a threshold relationship between endpoints of the first and second sequences of user inputs. Continuing with the example above, one or both of line 1105 and line 1200 have been adjusted so that endpoints (starting/ending of the respective lines) share a respective set of coordinates. As a result, user input does not need to be precise to draw lines with precise relationships. Similar adjustments are possible to, e.g., create an intersection at the center/midpoint of a line or shape, create parallel lines, create a tangential connection to an existing line, etc.

In one embodiment, once a relationship is detected and one or more lines are adjusted to display that relationship, subsequent manipulations of one line/shape can result in a translation through the relationship to also manipulate the other line/shape. For example, an embodiment can receive input to change the position or the size of a shape (e.g., increase the radius of a circle, area of a rectangle, length of a line, etc.). If another line/shape has been detected as having a relationship with the manipulated line/shape (e.g., concentric circles, parallel line, tangential line, etc.), the other line/shape can be altered in position or size to maintain the relationship.

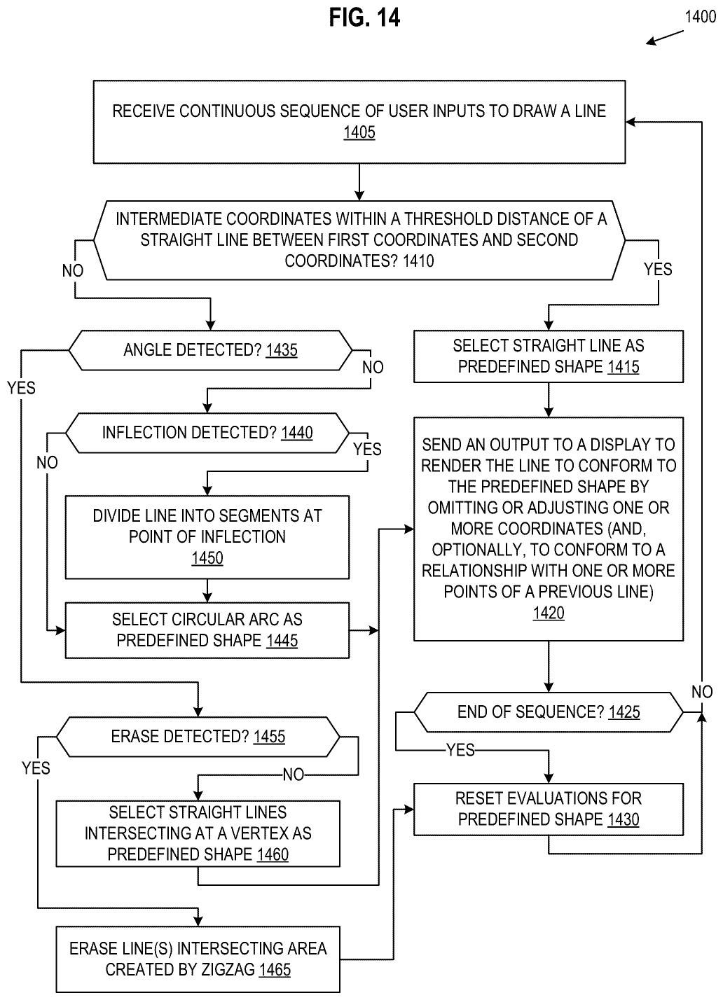

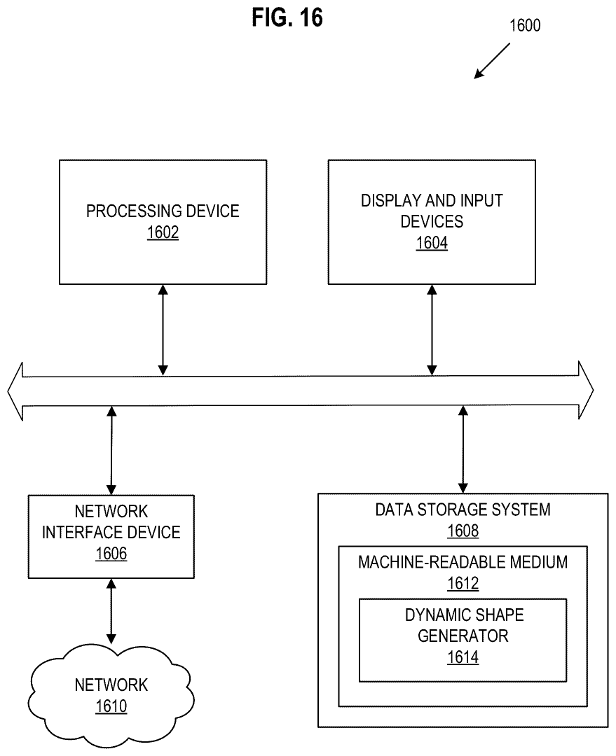

FIG. 14 is a flow chart illustrating an exemplary method 1400 of dynamic shape generation. The method 1400 can be performed by hardware (e.g., a processing device, circuitry, dedicated logic, programmable logic, etc.), software (e.g., instructions executed by a processing device), or a combination thereof. In some embodiments, the method 1400 is performed by a computer system, e.g., as described below with reference to FIG. 16. For ease of explanation, the operations are described as being performed by a processing device. Although operations are illustrated in a particular order, unless otherwise specified, the order can be modified, operations can be performed in parallel, one or more operations can be omitted, etc.

At operation 1405, the processing device receives a continuous sequence of inputs to draw a line. As described above, an example of a continuous sequence of inputs includes an initial contact between a stylus and a touchscreen, sets of coordinates as the stylus moves across the touchscreen, and a break in contact between the stylus and the touchscreen. Similar inputs via a controller, mouse, detected via video, etc. are possible, but examples set forth below focus on a stylus and touchscreen for ease of description.

At operation 1410, the processing device determines if the intermediate sets of coordinates along the line are within a threshold distance of a straight line between the initial set of coordinates and the latest set of coordinates. For example, the processing device determines if the sequence of inputs satisfies a straight line threshold as described above with reference to FIG. 1. If the straight line threshold is satisfied, the method 1400 proceeds to operation 1415. If the straight line threshold is not satisfied, the method 1400 proceeds to operation 1435.

At operation 1415, in response to detecting that the straight line threshold is satisfied, the processing device selects a straight line as a predefined shape for display. As described above, the straight line can be defined as passing between endpoints (starting and latest coordinates) of the user inputs.

At operation 1420, the processing device sends an output to a display to render the line to conform to the predefined shape. As described above, conforming the line to the predefined shape can include omitting or adjusting one or more sets of coordinates (e.g., intermediates sets of coordinates) along the line drawn by the user. Additionally or alternatively, conforming the line to the predefined shape can include adjusting one or more sets of coordinates to conform to a detected relationship (e.g., as described with reference to FIGS. 11-13). For example, if the predefined shape is a straight line, the rendered line is modified as described above with reference to FIG. 1.

At operation 1425, the processing device determines if the sequence of user inputs has ended. Continuing the example of drawing a line with a stylus on a touchscreen, the end of a sequence occurs when the stylus is no longer in contact with the touchscreen. If an end of the sequence of inputs is detected, the method 1400 proceeds to operation 1430. Otherwise, the method 1400 returns to operation 1405 to receive additional input and dynamically update the predefined shape when applicable.

At operation 1430, the processing device resets any stored coordinates, predefined shapes, relationships, vertices, etc. to enable evaluation of one or more of these parameters for a subsequent line. The method 1400 returns to operation 1405 to receive any additional input for a subsequent line.

At operation 1435, the processing device determines if the sequence of user inputs satisfies a vertex threshold corresponding to, e.g., straight lines sharing an endpoint to create a vertex of an angle. For example, the processing device detects a vertex or angle as described above with reference to FIG. 6. If the processing device detects a vertex, the method 1400 proceeds to operation 1455. Otherwise, the method 1400 proceeds to operation 1440.

At operation 1440, the processing device determines if the sequence of user inputs satisfies an inflection threshold. For example, the processing device detects an inflection as described above with reference to FIG. 5. If the processing device detects an inflection, the method 1400 proceeds to operation 1450. Otherwise, the method 1400 proceeds to operation 1445.

At operation 1445, the processing device the processing device selects a circular arc as a predefined shape for display. As described above, the circular arc can be a partial or complete circle defined as passing between endpoints (starting and latest coordinates) of the user inputs. In some embodiments, the processing device selects the circular arc in response to the sequence of user inputs failing to satisfy straight line and vertex thresholds. In other embodiments, the processing device selects the circular arc in response to the sequence of user inputs satisfying a circular arc threshold-e.g., sets of coordinates from the sequence of user inputs fall within a threshold distance of a circular arc as described with reference to FIG. 2. Accordingly, as the method 1400 proceeds to operation 1420, the processing device sends an output to a display to render the line to conform to a circular arc as described with reference to FIG. 2.

At operation 1450, the processing device divides the line/sequence of user inputs into segments at the detected point of inflection. For example, as described with reference to FIG. 5, the processing device can use the previously determined shape for the first segment and dynamically detect and update the second segment shape save the point of inflection as a new initial set of coordinates. In one embodiment, a point of inflection is detected on a circular arc. Accordingly, at operation 1445, the processing device confirms, updates, or otherwise selects a circular arc as the predefined shape for the first segment. In some embodiments, the processing device initially selects a circular arc as the predefined shape for the second segment as well. A subsequent loop through the method 1400, however, can lead to the processing device updating the selection of a shape for the second segment to another shape.

At operation 1455, the processing device determines if an erase threshold has been satisfied. For example, the processing device detects an erasure as described above with reference to FIGS. 8-9. If the processing device detects an erasure, the method 1400 dynamically updates the area of erasure until the end of the continuous sequence of inputs and proceeds to operation 1465. Otherwise, the method 1400 proceeds to operation 1460.

At operation 1460, the processing device selects straight lines intersecting at a vertex as the predefined shape. For example, as described with reference to FIG. 6, the processing device can use the vertex to divide the sequence of user inputs into straight line segments that intersect and create an angle at the vertex. In some embodiments, similar to the point of inflection described above, the processing device maintains a straight line as the selected shape for the first segment and continues to dynamically detect and update the shape of the second segment as the continuous user inputs are received. Additionally, at operation 1420, the processing device the processing device sends an output to a display to render the line to conform to an angle, e.g., as described with reference to FIG. 6.

At operation 1465, the processing device erases one or more lines within the area created by the detected erasure operation. For example, the processing device erases previously drawn lines/shapes as described with reference to FIGS. 9-10.

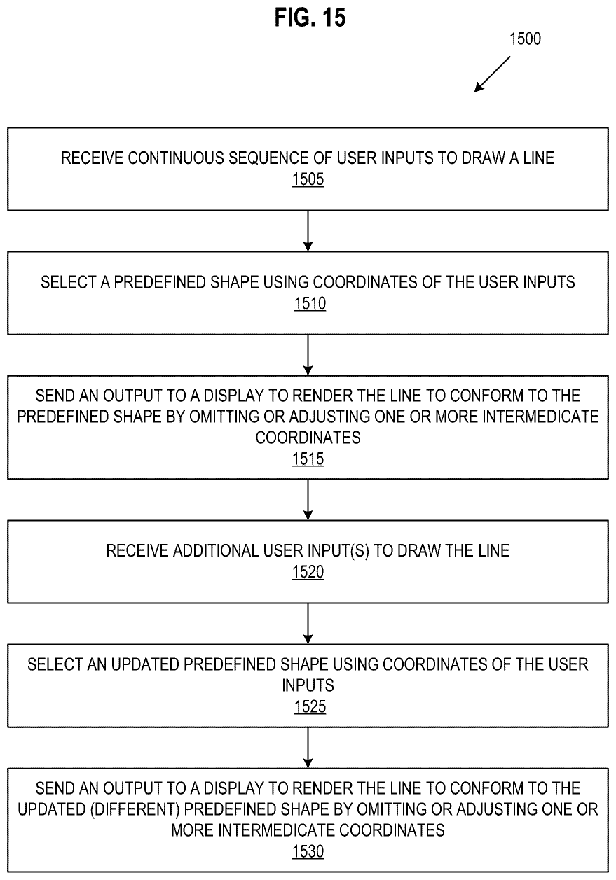

FIG. 15 is another flow chart illustrating an exemplary method 1500 of dynamic shape generation. The method 1500 can be performed by hardware (e.g., a processing device, circuitry, dedicated logic, programmable logic, etc.), software (e.g., instructions executed by a processing device), or a combination thereof. In some embodiments, the method 1500 is performed by a computer system, e.g., as described below with reference to FIG. 16. For ease of explanation, the operations are described as being performed by a processing device. Although operations are illustrated in a particular order, unless otherwise specified, the order can be modified, operations can be performed in parallel, one or more operations can be omitted, etc.

At operation 1505, the processing device receives a continuous sequence of inputs to draw a line. For example, the processing device receives inputs as described with reference to operation 1405.

At operation 1510, the processing device selects a predefined shape using coordinates of the user inputs. For example, the processing device determines if the intermediate coordinates of the line satisfy a straight line threshold as described with reference to operation 1410 and selects a straight line as the predefined shape or a circular arc as the predefined shape in response to the determination.

At operation 1515, the processing device sends an output to a display to render the line to conform to the predefined shape. For example, the processing device omits or adjusts one ore more of the intermediate coordinates to conform the line to the selected shape as described with reference to operation 1420.

At operation 1520, the processing device receives additional user input. For example, the processing device receives additional input as a stylus continues to make contact with and move across a touchscreen (or an equivalent drawing input).

At operation 1525, the processing device selects an updated predefined shape using coordinates of the user inputs. For example, the processing device determines if the updated set of intermediate coordinates of the line satisfy a straight line threshold as described with reference to operation 1410 and selects a straight line as the predefined shape or a circular arc as the predefined shape in response to the determination. As one example, the continuation of user inputs can result in the processing device updating the selected shape from a straight line to a circular arc as described with reference to FIGS. 1-2. Other dynamic adjustments to a selected shape are possible, including, e.g., an angle in response to the detection of a vertex.

At operation 1530, the processing device ends an updated output to a display to render the line to conform to the updated predefined shape. For example, the processing device omits or adjusts one or more of the intermediate coordinates to conform the line to the selected shape as described with reference to operation 1420.

FIG. 16 illustrates, in block diagram form, an exemplary computer system 1600 in which embodiments of the present disclosure can operate. In some embodiments, the computer system 1600 is a personal computer (PC), a tablet PC, a Personal Digital Assistant (PDA), a cellular telephone, a web appliance, a server, a network device, or any machine capable of executing a set of instructions (sequential or otherwise) that specify actions to be taken by that machine. Further, while a single system or machine is illustrated, the term “machine” shall also be taken to include any collection of machines that individually or jointly execute a set (or multiple sets) of instructions to perform any of the methods described above.

The computer system 1600 includes a processing device 1602. The processing device 1602 represents one or more general-purpose processing devices—e.g., a microprocessor, central processing unit, etc. The processing device 1602 implements one or more instruction sets—e.g., a complex instruction set computing (CISC) microprocessor, reduced instruction set computing (RISC) microprocessor, very long instruction word (VLIW) microprocessor, etc. Additionally, the processing device 1620 can be a special purpose processing device, such as an application specific integrated circuit (ASIC), a field programmable gate array (FPGA), etc.

The computer system 1600 further includes one or more display and input devices 1604. An input device enables user input to give a command to the computer system 1600 to draw a line while the output device displays the resulting line or shape to the user as described herein. For example, a touchscreen can serve as both a display and input device. Other display devices include a monitor, virtual reality headset, a projector, etc. Other input devices include a mouse, a stylus, a controller, a camera to capture user movement/gestures, etc.

The computer system 1600 further includes a network interface device 1606 to communicate over a network 1610. For example, instead of or in addition to receiving an input from an input device within the system, the computer system 1600 can receive an input via another computer system via the network 1610. Additionally, instead of or in addition to displaying an output to a display device within the system, the computer system 1600 can send an output via the network 1610 to be rendered via a display device of another computer system.

The computer system 1600 further includes a data storage system 1608. The data storage system 1608 includes a machine-readable medium 1612 (also known as a computer-readable medium) on which is stored instructions embodying a dynamic shape generator 1614 to perform the operations described herein. A machine-readable medium includes any mechanism for storing information in a form readable by a machine (e.g., a computer). In some embodiments, a machine-readable (e.g., computer-readable) medium includes a machine-readable storage medium such as a read only memory (“ROM”), random access memory (“RAM”), magnetic disk storage media, optical storage media, flash memory components, etc. The dynamic shape generator 1614 can also reside, completely or at least partially, within the processing device 1602 during execution thereof by the computer system 1600.

Aspects of the inventions may be embodied, at least in part, in software. That is, a computer system or other data processing system, such as computer system 1600 or other system including the dynamic shape generator 1614, may carry out the computer-implemented methods 1400 and 1500 in response to its processor executing sequences of instructions contained in a memory or other non-transitory machine-readable storage medium. The software may further be transmitted or received over a network (not shown) via a network interface. In various embodiments, hardwired circuitry may be used in combination with the software instructions to implement the present embodiments. It will also be appreciated that additional components, not shown, may also be part of computer system 1600, and, in some embodiments, fewer components than that shown in FIG. 16 may also be used in computer system 1600.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed in this document, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used in this document, the term “exemplary” refers to embodiments that serve as simply an example or illustration. The use of exemplary should not be construed as an indication of preferred examples. Blocks with dashed borders (e.g., large dashes, small dashes, dot-dash, dots) are used to illustrate optional operations that add additional features to embodiments of the invention. However, such notation should not be taken to mean that these are the only options or optional operations, and/or that blocks with solid borders are not optional in some embodiments of the invention. Numerous specific details are described to provide a thorough understanding of various embodiments of the present invention. However, in certain instances, well-known or conventional details are not described in order to provide a concise discussion of embodiments of the present inventions.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a continuous sequence of user inputs to draw a line, the sequence including a first input having a first set of coordinates, one or more intermediate inputs each having corresponding sets of intermediate coordinates, and a second input having a second set of coordinates;
selecting a predefined shape from a plurality of shapes by determining if a set of the intermediate coordinates is within a threshold distance of a straight line between the first set of coordinates and the second set of coordinates, the plurality of shapes including a straight line and a circular arc;
sending an output to a display to render the line from the first set of coordinates to the second set of coordinates in response the selection, wherein the rendered line conforms to the predefined shape by omitting or adjusting one or more of the intermediate coordinates;
receiving a third input as a part of the continuous sequence of user inputs to draw the line, the third input having a third set of coordinates that differs from the second set of coordinates, wherein the second set of coordinates and the intermediate coordinates become an updated set of intermediate coordinates upon receiving the third input;
selecting an updated predefined shape from the plurality of shapes by determining if a set of the updated intermediate coordinates is within the threshold distance of a straight line between the first set of coordinates and the third set of coordinates; and
sending an updated output to the display to render the line from the first set of coordinates to the third set of coordinates in response to the selection of the updated predefined shape, wherein the rendered line conforms to the updated predefined shape by omitting or adjusting one or more of the updated intermediate coordinates, and wherein the updated predefined shape is a different one of the plurality of shapes than the predefined shape.

2. The method of claim 1, wherein the predefined shape is the straight line between the first set of coordinates and the second set of coordinates, and where the straight line selected in response to determining the set of intermediate coordinates are within the threshold distance.

3. The method of claim 1, wherein the updated predefined shape is a circular arc defined by the straight line between the first set of coordinates and the third set of coordinates, the straight line being a unrendered chord, the circular arc rendered with a maximum distance from the chord at point equidistant from the first set of coordinates and the third set of coordinates, and the maximum distance being a maximum distance of the intermediate coordinates from the chord.

4. The method of claim 3, further comprising:
in response to determining that a circular center point of the circular arc is within a threshold distance of another circular center point of a previously rendered arc or circle, modifying the updated output to render the line as a concentric with the previously rendered arc or circle.

5. The method of claim 1, wherein the line is rendered to have a predefined relationship with a previously rendered line in response to determining the line satisfies a threshold with respect to the previously rendered line.

6. The method of claim 5, wherein the predefined relationship is the rendered line and previously rendered line being parallel lines and wherein satisfying the threshold includes a plurality of the sets of coordinates are within a threshold distance of being parallel to the previously rendered line.

7. The method of claim 5, wherein the predefined relationship is the rendered line and previously rendered line being lines bisecting one another equally, and wherein satisfying the threshold includes the line intersecting the previously rendered within a threshold distance of a center point of the previously rendered line.

8. The method of claim 1, wherein the updated predefined shape is an angle defined by dividing the straight line between the first set of coordinates and the third set of coordinates into two lines that share a common endpoint to create a vertex of the angle.

9. The method of claim 8, wherein a first set of intermediate coordinates is selected as the vertex in response to determining the first set of intermediate coordinates results a more acute angle than a plurality of surrounding intermediate coordinates would if selected as the vertex.

10. The method of claim 8, further comprising:
receiving additional inputs as a part of the continuous sequence of user inputs to draw the line;
detecting that the additional inputs correspond to updating the predefined shape to a zigzagging line; and
sending an output to remove from the display the rendered line and at least a portion of a previously rendered line intersected by an area defined by the zigzagging line.

11. A non-transitory computer-readable medium storing instructions, which when executed by a processing device, cause the processing device to perform a method comprising:
receiving a continuous sequence of user inputs to draw a line, the sequence including a first input having a first set of coordinates, one or more intermediate inputs each having corresponding sets of intermediate coordinates, and a second input having a second set of coordinates;
selecting a predefined shape from a plurality of shapes by determining if a set of the intermediate coordinates is within a threshold distance of a straight line between the first set of coordinates and the second set of coordinates, the plurality of shapes including a straight line and a circular arc;
sending an output to a display to render the line from the first set of coordinates to the second set of coordinates in response the selection, wherein the rendered line conforms to the predefined shape by omitting or adjusting one or more of the intermediate coordinates;
receiving a third input as a part of the continuous sequence of user inputs to draw the line, the third input having a third set of coordinates that differs from the second set of coordinates, wherein the second set of coordinates and the intermediate coordinates become an updated set of intermediate coordinates upon receiving the third input;
selecting an updated predefined shape from the plurality of shapes by determining if a set of the updated intermediate coordinates is within the threshold distance of a straight line between the first set of coordinates and the third set of coordinates; and
sending an updated output to the display to render the line from the first set of coordinates to the third set of coordinates in response to the selection of the updated predefined shape, wherein the rendered line conforms to the updated predefined shape by omitting or adjusting one or more of the updated intermediate coordinates, and wherein the updated predefined shape is a different one of the plurality of shapes than the predefined shape.

12. The non-transitory computer-readable medium of claim 11, wherein the predefined shape is the straight line between the first set of coordinates and the second set of coordinates, and where the straight line selected in response to determining the set of intermediate coordinates are within the threshold distance.

13. The non-transitory computer-readable medium of claim 11, wherein the updated predefined shape is a circular arc defined by the straight line between the first set of coordinates and the third set of coordinates, the straight line being a unrendered chord, the circular arc rendered with a maximum distance from the chord at point equidistant from the first set of coordinates and the third set of coordinates, and the maximum distance being a maximum distance of the intermediate coordinates from the chord.

14. The non-transitory computer-readable medium of claim 11, wherein the line is rendered to have a predefined relationship with a previously rendered line in response to determining the line satisfies a threshold with respect to the previously rendered line.

15. The non-transitory computer-readable medium of claim 14, wherein the predefined relationship is the rendered line and previously rendered line being parallel lines and wherein satisfying the threshold includes a plurality of the sets of coordinates are within a threshold distance of being parallel to the previously rendered line.

16. The non-transitory computer-readable medium of claim 14, wherein the predefined relationship is the rendered line and previously rendered line being lines bisecting one another equally, and wherein satisfying the threshold includes the line intersecting the previously rendered within a threshold distance of a center point of the previously rendered line.

17. The non-transitory computer-readable medium of claim 11, wherein the updated predefined shape is an angle defined by dividing the straight line between the first set of coordinates and the third set of coordinates into two lines that share a common endpoint to create a vertex of the angle.

18. The non-transitory computer-readable medium of claim 17, wherein a first set of intermediate coordinates is selected as the vertex in response to determining the first set of intermediate coordinates results a more acute angle than a plurality of surrounding intermediate coordinates would if selected as the vertex.

19. The non-transitory computer-readable medium of claim 17, the method further comprising:
receiving additional inputs as a part of the continuous sequence of user inputs to draw the line;
detecting that the additional inputs correspond to updating the predefined shape to a zigzagging line; and
sending an output to remove from the display the rendered line and at least a portion of a previously rendered line intersected by an area defined by the zigzagging line.

20. A system comprising:
a processing device; and
a memory coupled to the processing device, the memory storing instructions which, when executed by the processing device, cause the system to:
receive a continuous sequence of user inputs to draw a line, the sequence including a first input having a first set of coordinates, one or more intermediate inputs each having corresponding sets of intermediate coordinates, and a second input having a second set of coordinates;
select a predefined shape from a plurality of shapes by determining if a set of the intermediate coordinates is within a threshold distance of a straight line between the first set of coordinates and the second set of coordinates, the plurality of shapes including a straight line and a circular arc;
send an output to a display to render the line from the first set of coordinates to the second set of coordinates in response the selection, wherein the rendered line conforms to the predefined shape by omitting or adjusting one or more of the intermediate coordinates;
receive a third input as a part of the continuous sequence of user inputs to draw the line, the third input having a third set of coordinates that differs from the second set of coordinates, wherein the second set of coordinates and the intermediate coordinates become an updated set of intermediate coordinates upon receiving the third input;
select an updated predefined shape from the plurality of shapes by determining if a set of the updated intermediate coordinates is within the threshold distance of a straight line between the first set of coordinates and the third set of coordinates; and
send an updated output to the display to render the line from the first set of coordinates to the third set of coordinates in response to the selection of the updated predefined shape, wherein the rendered line conforms to the updated predefined shape by omitting or adjusting one or more of the updated intermediate coordinates, and wherein the updated predefined shape is a different one of the plurality of shapes than the predefined shape.
